(19) United States
(12) Patent Application Publication
(10) Pub. No.: US 2025/0102645 A1
(43) Pub. Date: Mar. 27, 2025

(54) LIDAR METHOD, SYSTEM AND VEHICLE INCLUDING THE SAME

(71) Applicant: BEIJING MORELITE SEMICONDUCTOR CO., LTD., Beijing (CN)

(72) Inventors: Dongquan ZHANG, Beijing (CN); Banghong ZHANG, Beijing (CN); Guan WANG, Beijing (CN); Tianbo SUN, Beijing (CN); Jie SUN, Beijing (CN)

(21) Appl. No.: 18/889,900

(22) Filed: Sep. 19, 2024

(30) Foreign Application Priority Data
Sep. 21, 2023 (CN) 202311223626.4

(51) Int. Cl. G01S 7/4915; G01S 7/481; G01S 17/58; G01S 17/931

(52) U.S. Cl. CPC G01S 7/4915; G01S 7/4814; G01S 17/58; G01S 17/931

(57) ABSTRACT

A LiDAR method and system and an autonomous vehicle are provided. The method includes: generating a frequency-sweeping beam which is split into a signal light beam and a local-oscillation light beam; transmitting the signal light beam; receiving a reflected light beam; performing time delay or frequency-shift on at least one of the signal light beam, the reflected light beam or the local-oscillation light beam, and/or performing in-phase quadrature coherent demodulation on the local-oscillation light beam and the reflected light beam, so as to obtain scalar values of beat frequencies between the local-oscillation light beam and the reflected light beam; determining a speed of an object and/or a distance between the object and the LiDAR system.

### CROSS-REFERENCE TO RELATED APPLICATION

This application claims a priority to Chinese Patent Application No. 202311223626.4 filed on Sep. 21, 2023, the disclosures of which are incorporated in their entirety by reference herein.

### TECHNICAL FIELD

The present disclosure relates to the field of laser measurement, and in particular to a Light Detection And Ranging (LiDAR) method applied to a LiDAR system, a LiDAR system and a vehicle including the LiDAR system.

### BACKGROUND

A Light Detection And Ranging (LiDAR) system can accurately measure a position (a distance and an angle), a motion state (speed, vibration and posture) and shape of a target object, detect, identify, distinguish and track the target object. The LiDAR technology can be divided into a pulsed LiDAR technology and a continuous wave LiDAR technology according to a working mode of the LiDAR technology. A typical continuous wave LiDAR system emits a laser beam and uses a detector to receive a reflected light beam of the target object from the nearby environment, thereby calculating information such as the distance and the speed of the target object. However, the reflected light beam used to calculate the distance and the speed includes the optical Doppler frequency shift introduced by the movement of the target object. When the target object moves fast, the frequency shift caused by the Doppler Effect is greater than a frequency offset caused by the flight time of the reflected light beam, which will lead to errors in the calculation of information of the target object within a close range, resulting in a measurement blind area.

### SUMMARY

In view of this, the present disclosure provides a LiDAR method applied to a LiDAR system, the LiDAR system and a vehicle including the LiDAR system, so as to solve the problem that when the LiDAR system in the related art measures the target object, and when the frequency shift caused by the Doppler effect is greater than the frequency offset caused by the flight time of the reflected light beam, errors are generated in the calculation of information of the object within a close range and a measurement blind area is generated.

In a first aspect, a Light Detection And Ranging (LiDAR) method applied to a LiDAR system is provided. The method includes: generating a frequency-sweeping beam; splitting the frequency-sweeping beam into a signal light beam and a local-oscillation light beam; transmitting the signal light beam; receiving a reflected light beam generated when the signal light beam is reflected by an object; performing time delay or frequency-shift on at least one of the signal light beam, the reflected light beam or the local-oscillation light beam, and/or performing in-phase quadrature coherent demodulation on the local-oscillation light beam and the reflected light beam, so as to obtain scalar values of a beat frequency between the local-oscillation light beam and the reflected light beam in a frequency-increasing phase and a beat frequency between the local-oscillation light beam and the reflected light beam in a frequency-decreasing phase; and detecting the beat frequency between the local-oscillation light beam and the reflected light beam in the frequency-increasing phase and the beat frequency between the local-oscillation light beam and the reflected light beam in the frequency-decreasing phase, to determine a speed of the object and/or a distance between the object and the LiDAR system.

Optionally, the scalar value of the beat frequency in the frequency-increasing stage includes a positive value, a zero value, or a negative value of the beat frequency of the frequency-increasing stage; the scalar value of the beat frequency in the frequency-decreasing stage includes a positive value, a zero value, or a negative value of the beat frequency of the frequency-decreasing stage.

Optionally, performing the time delay or the frequency-shift on at least one of the signal light beam, the reflected light beam or the local-oscillation light beam includes: delaying the signal light beam and the reflected light beam, or delaying the local-oscillation light beam, so that the beat frequency between the local-oscillation light beam and the reflected light beam of the frequency-increasing phase and the beat frequency between the local-oscillation light beam and the reflected light beam of the frequency-decreasing phase move toward a first direction or a second direction of a ranging spectrum of the LiDAR system.

Optionally, performing the time delay or the frequency-shift on at least one of the signal light beam, the reflected light beam or the local-oscillation light beam includes: performing frequency-shift of a frequency of the signal light beam or the local-oscillation light beam, so that the beat frequency of the frequency-increasing phase and the beat frequency of the frequency-decreasing phase between the local-oscillation light beam and the reflected light beam are shifted toward a first direction or a second direction of the ranging spectrum.

Optionally, performing the in-phase quadrature coherent demodulation on the local-oscillation light beam and the reflected light beam so as to obtain the scalar values of the beat frequency between the local-oscillation light beam and the reflected light beam in the frequency-increasing phase and the beat frequency between the local-oscillation light beam and the reflected light beam in the frequency-decreasing phase includes: inputting the reflected light beam and the local-oscillation light beam into a 90-degree frequency-mixer to obtain the scalar values of the beat frequency between the local-oscillation light beam and the reflected light beam in the frequency-increasing phase and the beat frequency between the local-oscillation light beam and the reflected light beam in the frequency-decreasing phase.

Optionally, a minimum value of the scalar values of the beat frequency in the frequency-increasing stage and the beat frequency in the frequency-decreasing stage is equal to a maximum negative frequency shift amount caused by the Doppler effect.

In a second aspect, a Light Detection And Ranging (LiDAR) system is provided. The system includes: a laser light source configured to generate a frequency-sweeping beam; a beam splitter configured to split the frequency-sweeping beam into a signal light beam and a local-oscillation light beam; an optical transceiver configured to transmit the signal light beam and receive a reflected light beam generated when the signal light beam is reflected by an object; a beat frequency scalar-value obtaining device, configured to perform time delay or frequency-shift on at least one of the signal light beam, the reflected light beam or the local-oscillation light beam, and/or perform in-phase quadrature coherent demodulation on the local-oscillation light beam and the reflected light beam, so as to obtain scalar values of a beat frequency between the local-oscillation light beam and the reflected light beam in a frequency-increasing phase and a beat frequency between the local-oscillation light beam and the reflected light beam in a frequency-decreasing phase; and a detector configured to detect the beat frequency between the local-oscillation light beam and the reflected light beam in the frequency-increasing phase and the beat frequency between the local-oscillation light beam and the reflected light beam in the frequency-decreasing phase, to determine a speed of the object and/or a distance between the object and the LiDAR system.

Optionally, the scalar value of the beat frequency in the frequency-increasing stage includes a positive value, a zero value, or a negative value of the beat frequency of the frequency-increasing stage; the scalar value of the beat frequency in the frequency-decreasing stage includes a positive value, a zero value, or a negative value of the beat frequency of the frequency-decreasing stage.

Optionally, the beat frequency scalar-value obtaining device specifically includes: a time delayer configured to delay the signal light beam and the reflected light beam, or delay the local-oscillation light beam, so that the beat frequency between the local-oscillation light beam and the reflected light beam of the frequency-increasing phase and the beat frequency between the local-oscillation light beam and the reflected light beam of the frequency-decreasing phase move toward a first direction or a second direction of a ranging spectrum of the LiDAR system.

Optionally, the beat frequency scalar-value obtaining device specifically includes: a frequency shifter configured to perform frequency-shift of a frequency of the signal light beam or the local-oscillation light beam, so that the beat frequency of the frequency-increasing phase and the beat frequency of the frequency-decreasing phase between the local-oscillation light beam and the reflected light beam are shifted toward a first direction or a second direction of the ranging spectrum.

Optionally, the beat frequency scalar-value obtaining device includes: a 90-degree frequency-mixer configured to receive the reflected light beam and the local-oscillation light beam to obtain the scalar values of the beat frequency between the local-oscillation light beam and the reflected light beam in the frequency-increasing phase and the beat frequency between the local-oscillation light beam and the reflected light beam in the frequency-decreasing phase.

Optionally, a minimum value of the scalar values of the beat frequency in the frequency-increasing stage and the beat frequency in the frequency-decreasing stage is equal to a maximum negative frequency shift amount caused by the Doppler effect.

In a third aspect, an autonomous vehicle. The vehicle includes the LiDAR system as mentioned in the above second aspect.

The solutions of the present application can obtain the beat frequencies of the frequency-increasing stage and the frequency-decreasing stage, and can expand the ranging spectrum of the LiDAR system, thereby avoiding the measurement blind area caused by the beat frequency of the frequency-increasing stage between the local-oscillation light beam and the reflected light beam being outside the ranging spectrum of the LiDAR system and improving the measurement accuracy.

### BRIEF DESCRIPTION OF THE DRAWINGS

FIG. 1 shows a schematic diagram of the structure of a continuous wave LiDAR system of the present application;

FIG. 2A shows a schematic diagram of measuring a stationary object using an existing triangular-wave linear Frequency-Modulation Continuous Wave (FMCW) LiDAR system;

FIG. 2B shows a schematic diagram of measuring a moving object using an existing triangular-wave linear Frequency-Modulation Continuous Wave (FMCW) LiDAR system;

FIG. 3 and FIG. 4 are schematic diagrams showing measurement blind areas caused by the Doppler Effect when using the existing LiDAR system to measure;

FIG. 5 is a schematic diagram showing the principle of measuring a target object moving towards the LiDAR system by using the triangular-wave linear Frequency-Modulation Continuous Wave (FMCW) LiDAR system and an IQ coherent demodulation method of the present application;

FIG. 6 a schematic diagram showing the principle of measuring a target object moving away from the LiDAR system by using the triangular-wave linear Frequency-Modulation Continuous Wave (FMCW) LiDAR system and an IQ coherent demodulation method of the present application;

FIG. 7 shows a schematic flowchart of the LiDAR method of the present application;

FIG. 8A and FIG. 8B are time-frequency domain schematic diagrams showing implementation of time delays of a signal light beam and a reflected light beam by using the LiDAR method of the present application;

FIG. 9A and FIG. 9B are time-frequency domain schematic diagrams showing implementation of the time delay of the local-oscillation light beam by using the LiDAR method of the present application;

FIG. 10 is a schematic diagram showing the frequency shifting of a local-oscillation light beam by using the LiDAR method of the present application;

FIG. 11 is a schematic diagram showing the frequency shifting of a signal light beam by using the LiDAR method of the present application;

FIG. 12 is a schematic diagram showing that a measurement spectrum of the LiDAR system is expanded by using the LiDAR method of the present application;

FIG. 13 shows a first schematic diagram of the structure of the LiDAR system of the present application;

FIG. 14 shows a second schematic diagram of the structure of the LiDAR system of the present application;

FIG. 15 shows a schematic diagram of the structure of the LiDAR system of the present application;

FIG. 16 shows a fourth schematic diagram of the structure of the LiDAR system of the present application; and

FIG. 17 and FIG. 18 show schematic diagrams of an autonomous vehicle including the LiDAR system of the present application.

### DETAILED DESCRIPTION

Specific embodiments of the present application will be described in detail hereinafter in conjunction with the accompanying drawings. When the following description refers to the drawings, unless otherwise indicated, the same numbers in different drawings represent the same or similar elements. In the following exemplary embodiments, the described embodiments are not all embodiments of the present application. On the contrary, they are only examples of devices and methods consistent with some aspects of the present application as detailed in the attached claims. In the absence of conflict, the embodiments in the present application and the features in the embodiments can be combined with each other.

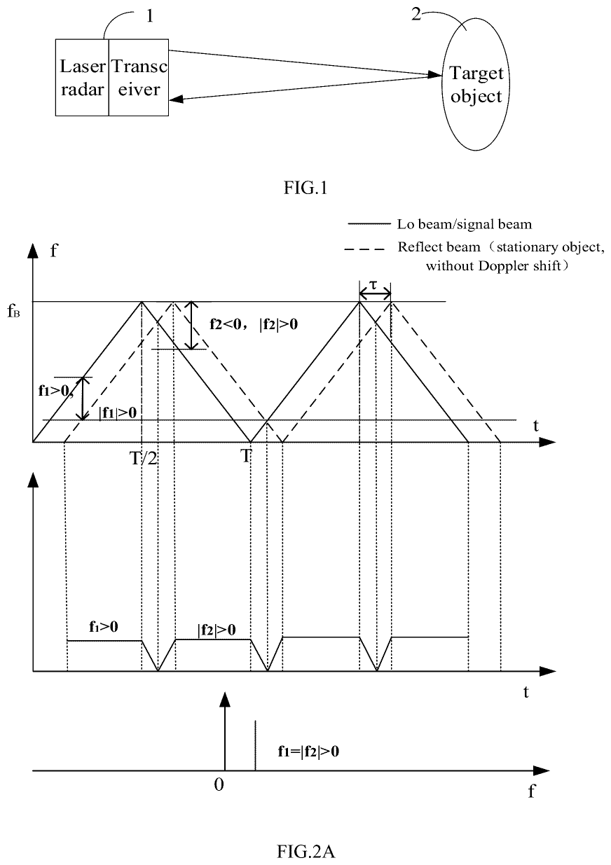

Refer to FIG. 1, which is a schematic diagram of the structure of the frequency-modulated continuous wave (FMCW) LiDAR system of the present application. The continuous wave LiDAR system 1 of the present application adopts the working principle of coherent reception. By comparing the instantaneous frequency relationship between the reflected light beam reflected from the target object 2 and the local-oscillation light beam of the LiDAR system 1, information such as the distance between the target object 2 and the LiDAR system 1 and the speed of the target object can be given at the same time.

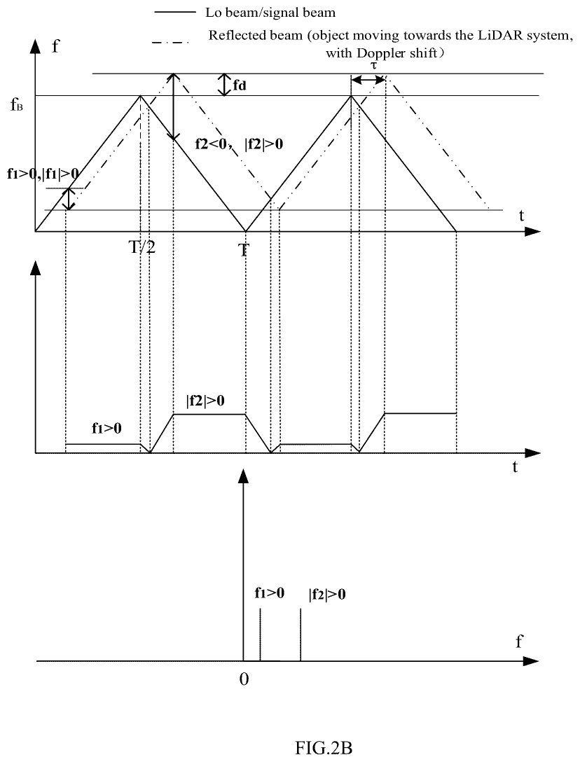

Referring to FIG. 2A, FIG. 2A shows a schematic diagram of measuring a stationary object by using an existing triangular wave linear frequency-modulation continuous wave (FMCW) LiDAR system. In FIG. 2A, a solid triangular wave is the instantaneous time-frequency relationship of the signal light beam or the local-oscillation light beam of the LiDAR system, and a dotted triangular wave is the reflected light beam of the stationary target object, wherein t is the delay of the reflected light beam of the stationary target object, f₁ and f₂ are the beat frequencies of the reflected light beam of the stationary object in an up-sweeping part and a down-sweeping part (i.e., the beat frequency between the reflected light beam and the local-oscillation light beam in a frequency-increasing stage and the beat frequency between the reflected light beam and the local-oscillation light beam in a frequency-decreasing stage), T is the period for the up-sweeping part and the down-sweeping part, and f_{B} is a frequency-sweeping bandwidth of the linear frequency modulation. In FIG. 2A, the beat frequencies of the frequency-increasing stage and the frequency-decreasing stage between the reflected light beam and the local-oscillation light beam are:

$${f}_{1} = \frac{2 {f}_{B}}{T} \cdot \frac{2 R}{c} \qquad Equation 1$$

$${f}_{2} = \frac{2 {f}_{B}}{T} \cdot \frac{2 R}{c}$$

Assuming that the distance between the target object and the LiDAR system is R, then R=τ*c/2, where c is the speed of light and λ is the wavelength of the laser light. Then in the time-frequency relationship diagram of FIG. 2A, the distance of the target object in the frequency-increasing stage of the reflected light beam is as follows:

$$R = \frac{( {f}_{1} + {f}_{2} ) \cdot T \cdot c}{8 {f}_{B}} \qquad Equation 2$$

FIG. 2B shows a schematic diagram of measuring an object moving towards the LiDAR system by using an existing triangular wave linear FMCW LiDAR system. In FIG. 2B, the solid triangular wave is the instantaneous time-frequency relationship of the signal light beam or the local-oscillation light beam of the LiDAR system, and the dotted triangular wave is the instantaneous time-frequency relationship of the reflected light beam of the target object moving towards the LiDAR system, where τ is the delay of the reflected light beam of the target object, f₁ and f₂ are the beat frequencies of the reflected light beam of the target object in the up-sweeping part and the down-sweeping part (i.e., the beat frequency between the reflected light beam and the local-oscillation light beam in the frequency-increasing stage and the beat frequency between the reflected light beam and the local-oscillation light beam in the frequency-decreasing stage), T is the period of the up-sweeping part and the down-sweeping part, f_{B} is the frequency-sweeping bandwidth of the linear frequency modulation, and f_{d}=(f₂f₁)/2. In FIG. 2B, the beat frequencies in the frequency-increasing stage and the frequency-decreasing stage of the reflected light beam are respectively:

$${f}_{1} = \frac{2 {f}_{B}}{T} \cdot \frac{2 R}{c} - \frac{2 v}{λ} \qquad Equation 3$$

$${f}_{2} = \frac{2 {f}_{B}}{T} \cdot \frac{2 R}{c} + \frac{2 v}{λ}$$

The distance R and the speed v of the target object are as follows:

$$\{ \begin{matrix}R = \frac{( {f}_{1} + {f}_{2} ) \cdot T \cdot c}{8 {f}_{B}} \\ v = \frac{( {f}_{2} - {f}_{1} ) \cdot λ}{4}\end{matrix} \qquad Equation 4$$

When f₁=0, the relationship between the distance and the speed can be expressed as follows:

$${R}_{m} = \frac{v \times T \times c}{2 \times λ \times {f}_{B}} \qquad Equation 5$$

In the above Equation 4, in order to avoid measuring blind areas, the absolute values of f₁ and f₂ are required, that is, both f₁ and f₂ are required to be greater than 0, and the actual distance between the LiDAR system and the target object needs to be greater than the value Rₘ of R calculated by the above Equation, that is, it is necessary to ensure that R>Rm, that is

$$R > \frac{v \times T \times c}{2 \times λ \times {f}_{B}} .$$

If R is less than the above value Rₘ, then errors in the calculation of the speed and the distance will occur. In addition, it can be seen from Equation 5 that R is proportional to the speed v of the target object. The larger the speed v of the target object is, the larger the above R is.

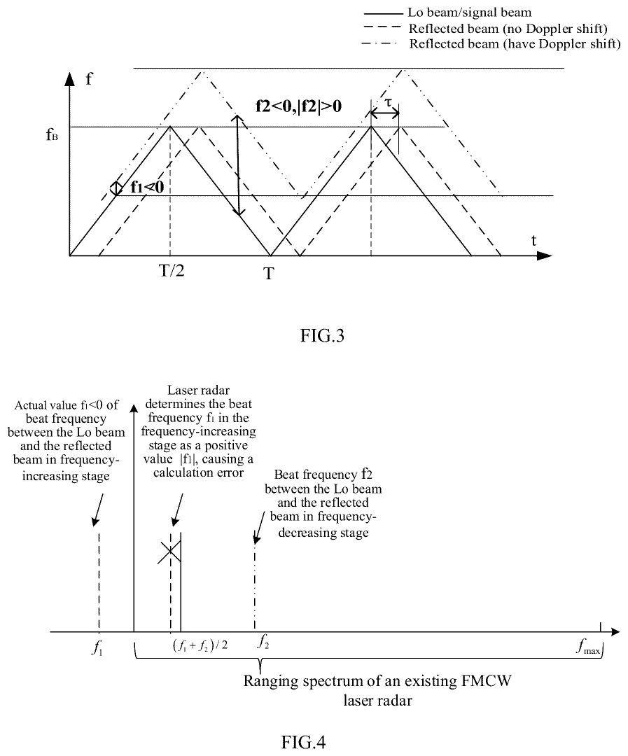

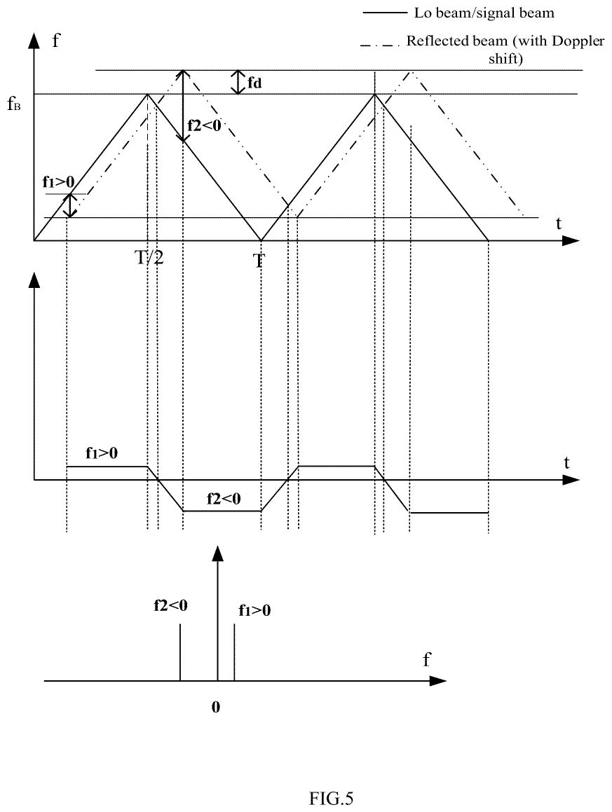

In addition, both in Equation 3 and in Equation 4 above, it is assumed that f₂ and f₁ are greater than 0, and the absolute values, i.e., positive values, of f₁ and f₂ above are required to obtain the calculated distance R between the target object and the LiDAR system and the speed v of the target object. However, when the actual speed v of the target object is sufficiently large, the frequency shift caused by the Doppler effect may be greater than the frequency offset caused by the flight time of the reflected light beam, resulting in the actual value of the beat frequency f₁ between the local-oscillation light beam and the received reflected light beam in the frequency-increasing stage being a negative value, as shown in FIG. 3 and FIG. 4. Although the beat frequency f₁ between the local-oscillation light beam and the received reflected light beam in the frequency-increasing stage is actually a negative value (i.e., less than 0), the LiDAR system judges the frequency f₁ as a positive value (i.e., greater than 0), so when the above Equations are used to calculate the distance and the speed of the target object, errors will occur in the calculation of the distance and the speed, resulting in a measurement blind area. In addition, when a rotating mirror device of the LiDAR system rotates at a high speed, a large Doppler frequency shift will also be generated. The Doppler frequency shift introduced by the rotation of the rotating mirror and the Doppler frequency shift of the target object will be superimposed on each other, which will also cause the frequency shift caused by the Doppler effect to exceed the frequency offset caused by the flight time of the reflected light beam, thereby causing calculation errors in the distance and the speed of the target object and causing a measurement blind area.

In view of the above problems, the technical solutions of the present application adopt the method of In-phase Quadrature (IQ) coherent demodulation. The technical solutions of the present application obtain the actual value of the beat frequency in the frequency-increasing stage and the beat frequency in the frequency-decreasing phase between the reflected light beam and the local-oscillation light beam, that is, the technical solutions of the present application obtain the scalar value of the beat frequency of the up-sweeping part and the beat frequency of the down-sweeping part, rather than the absolute value of the beat frequency of the frequency-increasing stage and the absolute value of the beat frequency of the frequency-decreasing stage (which are values greater than 0), which can effectively avoid the ranging blind area. The scalar value in the present application is a positive value or a negative value or a zero value, i.e., a value greater than 0 or less than 0 or equal to 0.

Refer to FIG. 5, which is a schematic diagram of the principle of measuring a target object moving towards the LiDAR system by using the IQ coherent demodulation method of the present application. When the target object moves towards the LiDAR system, the frequency of the reflected light beam increases relative to the frequency of the local-oscillation light beam. At this time, the beat frequency of the reflected light beam in the frequency-increasing stage and the beat frequency in the frequency-decreasing stage are respectively:

$${f}_{1} = \frac{2 {f}_{B}}{T} \cdot \frac{2 R}{c} - \frac{2 v}{λ} \qquad Equation 6$$

$${f}_{2} = - \frac{2 {f}_{B}}{T} \cdot \frac{2 R}{c} - \frac{2 v}{λ}$$

The distance and the speed of the target object are as follows:

$$\{ \begin{matrix}R = \frac{( {f}_{1} - {f}_{2} ) \cdot T \cdot c}{8 {f}_{B}} \\ v = - \frac{( {f}_{2} + {f}_{1} ) \cdot λ}{4}\end{matrix} \qquad Equation 7$$

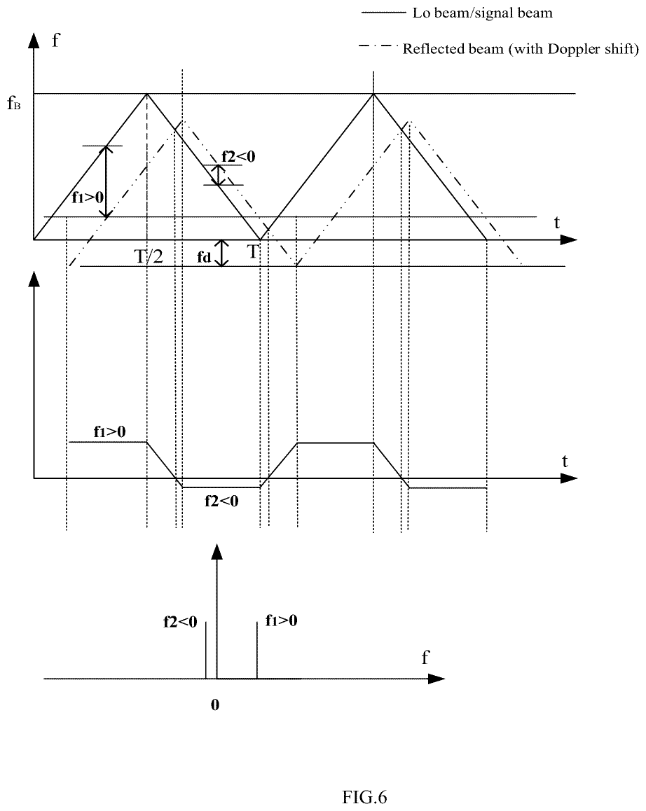

Refer to FIG. 6, which is a schematic diagram of the principle of measuring a target object moving away from the LiDAR system by using the IQ coherent demodulation method of the present application. When the target object moves away from the LiDAR system, the frequency of the reflected light beam decreases relative to the frequency of the local-oscillation light beam. At this time, the beat frequency of the reflected light beam in the frequency-increasing stage and the beat frequency of the reflected light beam in the frequency-decreasing stage are respectively:

$${f}_{1} = \frac{2 {f}_{B}}{T} \cdot \frac{2 R}{c} + \frac{2 v}{λ} \qquad Equation 8$$

$${f}_{2} = - \frac{2 {f}_{B}}{T} \cdot \frac{2 R}{c} + \frac{2 v}{λ}$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} ) \cdot λ}{4}\end{matrix} \qquad Equation 9$$

By using the above Equations 6-9, the solutions of the present application can accurately obtain the scalar value of the beat frequency in the frequency frequency-increasing stage and the beat frequency in the frequency frequency-decreasing stage, rather than just the absolute values of the beat frequencies, thereby expanding the measurement range (i.e., the ranging spectrum) of the LiDAR system. In addition, when the existing LiDAR method is used to measure the distance and the speed of the target object, if the speed of the target object is too fast or the distance between the target object and the LiDAR system is too close, it may cause the beat frequency in the frequency frequency-increasing stage and the beat frequency in the frequency frequency-decreasing stage to be outside the frequency range of the ranging spectrum of the existing LiDAR system, resulting in a ranging blind area, as shown in FIG. 4. The solution of the present application accurately obtains the scalar values of the beat frequencies in the frequency-increasing stage and in the frequency-decreasing stage, and can avoid the ranging blind area.

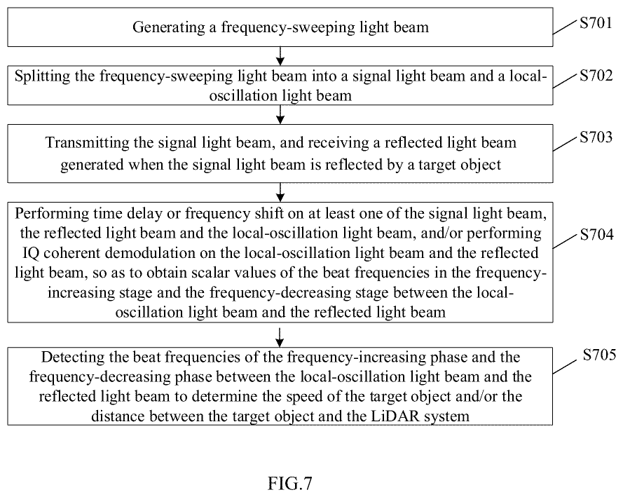

In some embodiments, the present disclosure provides a LiDAR method. The LiDAR method can be applied to a frequency-modulated continuous wave (FMCW) LiDAR system. As shown in FIG. 7, the LiDAR method includes the following steps S701-S705.

Step S701: generating a frequency-sweeping light beam.

Specifically, the frequency-sweeping light beam can be generated by a laser light source. The laser light source can be directly driven and modulated by a chirp signal of an optical signal. For example, a driving signal for controlling the laser light source can be input to the laser light source with an intensity that varies with time, so that the laser light source generates and outputs a frequency-sweeping beam, i.e., a beam whose frequency varies within a predetermined range.

In some embodiments, the laser light source may further include a modulator that receives a modulation signal. The modulator may be configured to modulate the light beam based on the modulation signal to generate and output a frequency-sweeping light beam, the frequency of which varies within a predetermined range. The principle of generating a frequency-sweeping light beam by the FMCW LiDAR system is well known to those skilled in the art. In order to avoid repetition, the details of the principle will not be further described here.

Step S702: splitting the frequency-sweeping light beam into a signal light beam and a local-oscillation light beam.

In some examples, a beam splitter may be used to split the frequency sweeping light beam into a signal light beam and a local-oscillation light beam. The signal light beam and the local-oscillation light beam have the same frequency at any time instant, that is, the frequency modulation waveforms of the signal light beam and the local-oscillation light beam are exactly the same. In some examples, the beam splitter may be a specific wavelength coupler (beam splitter) for wavelengths of 445 to 2100 nm, such as a beam splitter based on a 1×2 beam splitter on an optical chip and an SMC series. In other examples, other beam splitters known to those skilled in the art that can split the frequency-sweeping light beam into a signal light beam and a local-oscillation light beam may also be used.

Step S703: emitting the signal light beam, and receiving a reflected light beam generated when the signal light beam is reflected by a target object.

In some examples, an optical transmitter or an optical transceiver is used to emit the signal light beam at a predetermined angle, and a light receiver or the optical transceiver is used to receive the reflected light beam reflected by the target object.

Step S704: performing time delay or frequency shift on at least one of the signal light beam, the reflected light beam and the local-oscillation light beam, and/or perform In-phase and Quadrature (IQ) coherent demodulation on the local-oscillation light beam and the reflected light beam, so as to obtain scalar values of the beat frequency in the frequency-increasing stage and the beat frequency in the frequency-decreasing stage between the local-oscillation light beam and the reflected light beam.

In an embodiment of the present application, the moving target object is measured by using an IQ coherent demodulation method, and the beat frequency f₁ (i.e., frequency difference) in the frequency-increasing stage between a rising edge of the local-oscillation light beam and a rising edge of the reflected light beam and the beat frequency f₂ (i.e., frequency difference) in the frequency-decreasing stage between a falling edge of the local-oscillation light beam and a falling edge of the reflected light beam can be obtained. The scalar values (i.e., values with positive or negative signs) of the beat frequencies can be obtained, so that the frequency range of the negative frequency band can be fully utilized, and the ranging spectrum of the LiDAR system can be expanded. The measurement spectrum of the LiDAR system refers to the frequency range of the beat frequency f₁ in the frequency-increasing stage and the beat frequency f₂ in the frequency-decreasing stage that can be measured by the LiDAR system. In the existing FMCW LiDAR system, the frequency range of the ranging spectrum can be [0, +fₘₐₓ], where fₘₐₓ is the maximum value of the beat frequency in the frequency-decreasing stage between the local-oscillation light beam of the LiDAR system and the reflected light beam, so the existing FMCW LiDAR system can only obtain the absolute values (the positive values) of the beat frequency in the frequency-increasing stage and the beat frequency in the frequency-decreasing stage. Due to the influence of the Doppler effect, when the distance between the target object and the LiDAR system is close enough or the relative speed is fast enough, the actual value of the beat frequency f₁ between the rising edge of the local-oscillation light beam and the rising edge of the reflected light beam or the actual value of the beat frequency f₁ between the falling edge of the local-oscillation light beam and the falling edge of the reflected light beam may be negative. Therefore, if the ranging spectrum of the existing LiDAR system is used, the actual value of the beat frequency f₁ in the frequency-increasing stage may be outside the frequency range of the ranging spectrum, thereby causing errors in the calculation of the speed and the distance of the target object, resulting in a measurement blind area, as shown in FIG. 3 and FIG. 4. The present application adopts an IQ coherent demodulation technical solution, which can obtain the scalar values (i.e., positive or negative value) of the beat frequency in the frequency-increasing stage and the beat frequency in the frequency-decreasing stage, and can implement frequency shift of at least one of the beat frequency in the frequency-increasing stage and the beat frequency in the frequency-decreasing stage between the local-oscillation light beam and the reflected light beam according to the measurement needs, so that the beat frequency in the frequency-increasing stage and the beat frequency in the frequency-decreasing stage can be located within the frequency range of the ranging spectrum of the LiDAR system, thereby expanding the ranging spectrum of the LiDAR system, avoiding errors in the calculation of the speed and the distance of the target object, and avoiding a measurement blind area.

Specifically, a 90-degree frequency-mixer can be used to obtain the measurement values of the beat frequency in the frequency-increasing stage and the beat frequency in the frequency-decreasing stage of the LiDAR system. In some embodiments, in-phase and quadrature coherent demodulation of the local-oscillation light beam and the reflected light beam is implemented to obtain the scalar values of the beat frequency in the frequency-increasing stage and the beat frequency in the frequency-decreasing stage between the local-oscillation light beam and the reflected light beam, includes: inputting the reflected light beam and the local-oscillation light beam into a 90-degree frequency-mixer to obtain the scalar values of the beat frequency in the frequency-increasing stage and the beat frequency in the frequency-decreasing stage between the local-oscillation light beam and the reflected light beam. The 90-degree frequency-mixer can perform 90-degree frequency-mixing on the local-oscillation light beam and the reflected light beam, and input the mixed signal into a first balanced detector and a second balanced detector for detection. The 90-degree frequency-mixer is configured to coherently mix the local-oscillation light beam and the reflected light beam so that the relative phase differences of the four output ports of the 90-degree frequency-mixer are 0°, 90°, 180°, and 270°, respectively. The 90-degree frequency-mixer can be a 90-degree frequency-mixer known to those skilled in the art, and will not be described in detail here.

In some embodiments, performing the time delay or the frequency shift on at least one of the signal light beam, the reflected light beam, and the local-oscillation light beam includes: performing the time delay on the signal light beam and the reflected light beam, or performing the time delay on the local-oscillation light beam, so that the beat frequency of the frequency-increasing phase and the beat frequency of the frequency-decreasing phase between the local-oscillation light beam and the reflected light beam move toward a first direction or a second direction of the X axis of the ranging spectrum of the LiDAR system.

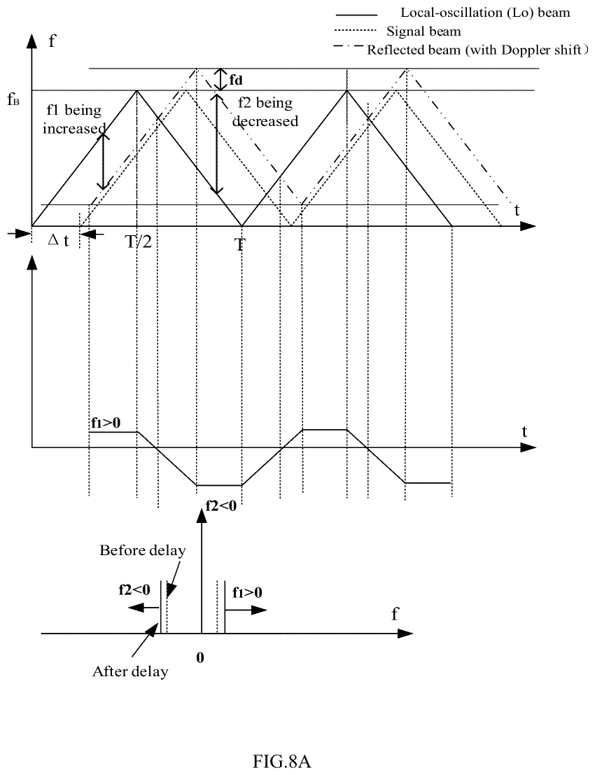

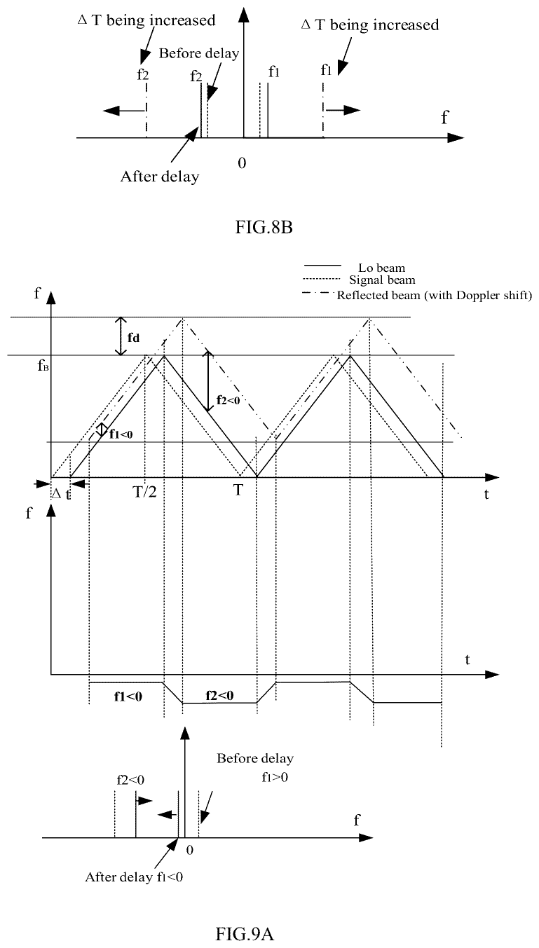

As shown in FIG. 8A, in this embodiment, when both the signal light beam and the reflected light beam are delayed by Δt, when the target object moves away from the LiDAR system, the beat frequencies of the reflected light beam in the frequency-increasing stage and the frequency-decreasing stage are respectively:

$${f}_{1} = \frac{2 {f}_{B}}{T} \cdot ( \frac{2 R}{c} + Δ t ) + \frac{2 v}{λ} \qquad Equation 10$$

$${f}_{2} = - \frac{2 {f}_{B}}{T} \cdot ( \frac{2 R}{c} + Δ t ) + \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} - \frac{1}{2} Δ t ] \times c \\ v = \frac{( {f}_{2} + {f}_{1} ) \cdot λ}{4}\end{matrix} \qquad Equation 11$$

When the target object moves toward the LiDAR system, the frequency of the reflected light beam increases relative to the frequency of the local-oscillation light beam. At this time, the beat frequencies of the reflected light beam in the frequency-increasing stage and the frequency-decreasing stage are:

$${f}_{1} = \frac{2 {f}_{B}}{T} \cdot ( \frac{2 R}{c} + Δ t ) - \frac{2 v}{λ} \qquad Equation 12$$

$${f}_{2} = - \frac{2 {f}_{B}}{T} \cdot ( \frac{2 R}{c} + Δ t ) - \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} - \frac{1}{2} Δ t ] \times c \\ v = - \frac{( {f}_{2} + {f}_{1} ) \cdot λ}{4}\end{matrix} \qquad Equation 13$$

As shown in FIG. 8B, when Δt increases, the beat frequency f₁ in the frequency-increasing stage and the beat frequency f₂ in the frequency-decreasing phase between the local-oscillation light beam and the reflected light beam move in opposite directions, thereby the spacing between the beat frequencies f₁ and f₂ is broaden. Vice versa, when Δt decreases, the beat frequency f₁ in the frequency-increasing stage and the beat frequency f₂ in the frequency-decreasing phase between the local-oscillation light beam and the reflected light beam move in opposite directions, thereby the spacing between the beat frequencies f₁ and f₂ is narrowed. When Δt continues to decrease, the beat frequency f₁ in the frequency-increasing stage and the beat frequency f₂ in the frequency-decreasing phase may pass each other and continue to move in opposite directions, thereby the spacing therebetween is decreased to zero and then is broaden.

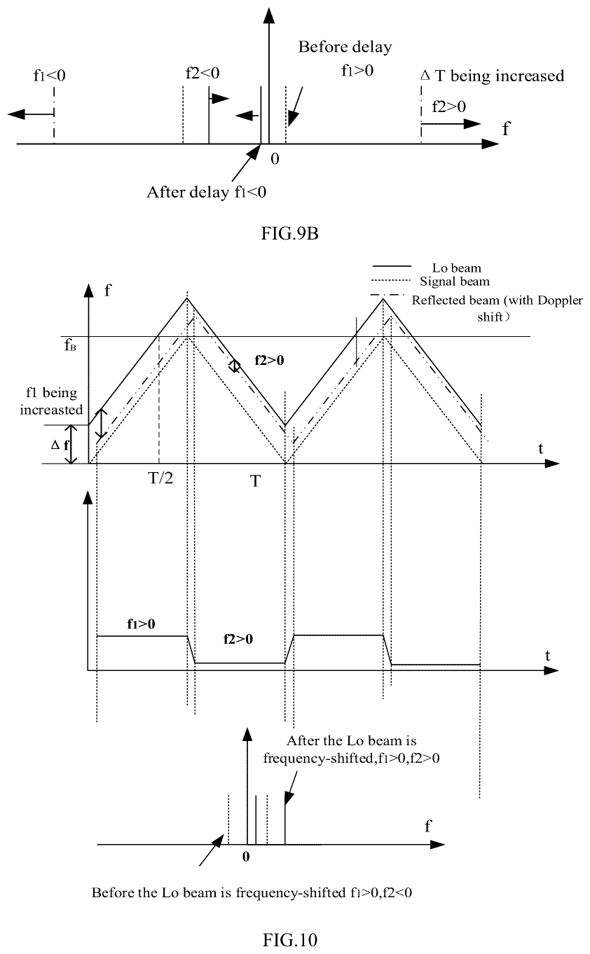

In FIG. 9A, in this embodiment, the local-oscillation signal is delayed by Δt. When the target object moves away from the LiDAR system, the beat frequencies of the reflected light beam in the frequency-increasing stage and the frequency-decreasing stage are respectively:

$${f}_{1} = \frac{2 {f}_{B}}{T} \cdot ( \frac{2 R}{c} - Δ t ) + \frac{2 v}{λ} \qquad Equation 14$$

$${f}_{2} = - \frac{2 {f}_{B}}{T} \cdot ( \frac{2 R}{c} - Δ t ) + \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} + \frac{1}{2} Δ t ] \times c \\ v = \frac{( {f}_{2} + {f}_{1} ) \cdot λ}{4}\end{matrix} \qquad Equation 15$$

When the target object moves toward the LiDAR system, the frequency of the reflected light beam increases relative to the frequency of the local-oscillation light beam. At this time, the beat frequencies of the reflected light beam in the frequency-increasing stage and the frequency-decreasing stage are:

$${f}_{1} = \frac{2 {f}_{B}}{T} \cdot ( \frac{2 R}{c} - Δ t ) - \frac{2 v}{λ} \qquad Equation 16$$

$${f}_{2} = - \frac{2 {f}_{B}}{T} \cdot ( \frac{2 R}{c} - Δ t ) - \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} + \frac{1}{2} Δ t ] \times c \\ v = - \frac{( {f}_{2} + {f}_{1} ) \cdot λ}{4}\end{matrix} \qquad Equation 17$$

As shown in FIG. 9B, when Δt increases, the beat frequency f₁ in the frequency-increasing stage and the beat frequency f₂ in the frequency-decreasing phase between the local-oscillation light beam and the reflected light beam move in opposite directions, thereby the spacing therebetween is reduced. When Δt continues to increase, the beat frequency f₁ in the frequency-increasing stage and the beat frequency f₂ in the frequency-decreasing phase may cross each other and continue to move in opposite directions, thereby the spacing is reduced to zero and then increased. Vice versa, when Δt decreases, the beat frequency f₁ in the frequency-increasing stage and the beat frequency f₂ in the frequency-decreasing phase between the local-oscillation light beam and the reflected light beam move in opposite directions, thereby the spacing therebetween is increased.

In the above embodiment, both the signal light beam and the reflected light beam can be delayed, or the local-oscillation light beam can be delayed. By delaying one or more of the signal light beam, the reflected light beam and the local-oscillation light beam, the positions of the beat frequency f₁ in the frequency-increasing phase and the beat frequency f₂ in the frequency-decreasing phase between the local-oscillation light beam and the reflected light beam on the ranging spectrum of the LiDAR system can be changed. The speed of the target object and the distance between the LiDAR system and the target object can be correctly calculated according to the above equations, avoiding the measurement blind area and improving the measurement accuracy. In addition, due to the use of delay, the time delay system can be used as the measurement scale of the LiDAR system to accurately obtain the frequency position of the measurement zero point.

In some embodiments, a time delay device may be used to shift the frequency of the signal light beam and the reflected light beam. The number of time delay devices may be one or more (e.g., multiple time delay devices connected in series, such as delay optical fibers), so that one or more of the signal light beam, the reflected light beam, and the local-oscillation light beam are all delayed. The parameters of the time delay devices may be defined according to the performance of the LiDAR system and the maximum moving speed of the target object, and will not be described in detail in the present application.

In some embodiments, performing time-delaying or frequency-shifting on at least one of the signal light beam, the reflected light beam, and the local-oscillation light beam includes: performing frequency-shifting on the frequency of the signal light beam or the local-oscillation light beam so that the beat frequency of the frequency-increasing phase and the beat frequency of the frequency-decreasing phase between the local-oscillation light beam and the reflected light beam are shifted toward the first direction or the second direction of the X axis of the ranging spectrum.

In some embodiments, the first direction of the X axis of the ranging spectrum is the direction of increasing frequency, i.e., the positive frequency direction, which is the rightward direction in FIG. 4; the second direction of the X axis of the ranging spectrum is the direction of decreasing frequency, i.e., the negative frequency direction.

In some embodiments, when the frequency of the local-oscillation light beam is shifted, the frequency of the local-oscillation light beam may be increased or decreased as a whole. For example, as shown in FIG. 10, the frequency of the local-oscillation light beam is increased as a whole by Δf. When the target object moves away from the LiDAR system, the beat frequency in the frequency frequency-increasing stage and the beat frequency in the frequency frequency-decreasing stage are respectively:

$${f}_{1} = \frac{2 {f}_{B}}{T} \cdot \frac{2 R}{c} + \frac{2 v}{λ} + Δ f \qquad Equation 18$$

$${f}_{2} = - \frac{2 {f}_{B}}{T} \cdot \frac{2 R}{c} + \frac{2 v}{λ} + Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} - 2 Δ f ) \cdot λ}{4}\end{matrix} \qquad Equation 19$$

When the target object moves toward the LiDAR system, the beat frequencies in the frequency-increasing phase and the frequency-decreasing phase are:

$${f}_{1} = \frac{2 {f}_{B}}{T} \cdot \frac{2 R}{c} - \frac{2 v}{λ} + Δ f \qquad Equation 20$$

$${f}_{2} = - \frac{2 {f}_{B}}{T} \cdot \frac{2 R}{c} - \frac{2 v}{λ} + Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} - 2 Δ f ) \cdot λ}{4}\end{matrix} \qquad Equation 21$$

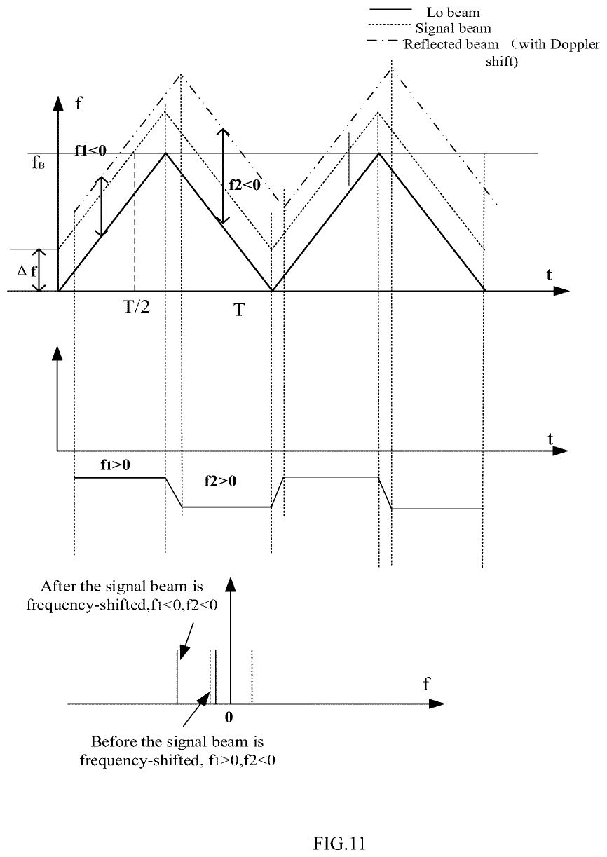

In some embodiments, when the frequency of the signal light beam is shifted, the frequency of the signal light beam may be increased or decreased as a whole. For example, as shown in FIG. 11, the frequency of the signal light beam is increased as a whole by Δf. When the target object moves away from the LiDAR system, the beat frequency in the frequency-increasing stage and the beat frequency in the frequency-decreasing stage are respectively:

$${f}_{1} = \frac{2 {f}_{B}}{T} \cdot \frac{2 R}{c} + \frac{2 v}{λ} - Δ f \qquad Equation 22$$

$${f}_{2} = - \frac{2 {f}_{B}}{T} \cdot \frac{2 R}{c} + \frac{2 v}{λ} - Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} + 2 Δ f ) \cdot λ}{4}\end{matrix} \qquad Equation 23$$

When the target object moves toward the LiDAR system, the beat frequencies in the frequency-increasing phase and the frequency-decreasing phase are:

$${f}_{1} = \frac{2 {f}_{B}}{T} \cdot \frac{2 R}{c} - \frac{2 v}{λ} - Δ f \qquad Equation 24$$

$${f}_{2} = - \frac{2 {f}_{B}}{T} \cdot \frac{2 R}{c} - \frac{2 v}{λ} - Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( - {f}_{2} - {f}_{1} - 2 Δ f ) \cdot λ}{4}\end{matrix} \qquad Equation 25$$

In some embodiments, a minimum value of the scalar values of the beat frequency in the frequency-increasing phase and the beat frequency in the frequency-decreasing phase is equal to a maximum negative frequency shift amount caused by the Doppler effect.

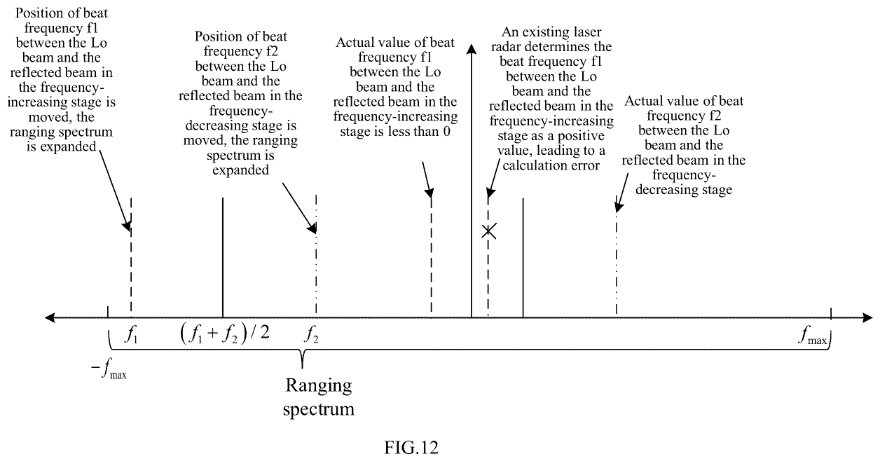

In the embodiments of the present disclosure, as shown in FIG. 12, by shifting the frequencies of the local-oscillation light beam and/or the signal light beam, the positions of the beat frequency in the frequency-increasing stage and the beat frequency in the frequency-decreasing stage on the ranging spectrum of the LiDAR system can be changed. Combined with the IQ coherent demodulation method of the present application, the frequency range of the ranging spectrum of the LiDAR system can be expanded from [0, fₘₐₓ] to [fₘₐₓ, fₘₐₓ], thereby avoiding measurement blind areas.

Step S705: detecting the beat frequency of the frequency-increasing phase and the beat frequency of the frequency-decreasing phase between the local-oscillation light beam and the reflected light beam to determine the speed of the target object and/or the distance between the target object and the LiDAR system.

Specifically, a balanced detector can be used to measure the beat frequency of the local-oscillation light beam and the reflected light beam. The balanced detector can be a photoelectric detector.

In some embodiments, step S705 specifically includes: mixing the received reflected light beam with the local-oscillation light beam to obtain a mixed signal.

The local-oscillation light beam is mixed with the received reflected light beam by a mixer to obtain a mixed signal. The mixer may be a coupler, such as a 2×2 coupler, and the mixed signal may be a coherent signal generated by interference between the local-oscillation light beam and the corresponding reflected light beam. The mixer or coupler may be a mixer and a coupler well known to those skilled in the art. In order to avoid repetition, details will not be described here.

The above-mentioned technical solutions of the present application obtain the actual value of the beat frequency in the frequency-increasing stage between the local-oscillation light beam and the reflected light beam, so that the ranging spectrum of the LiDAR system is expanded, the measurement blind area is avoided, and the measurement accuracy is improved.

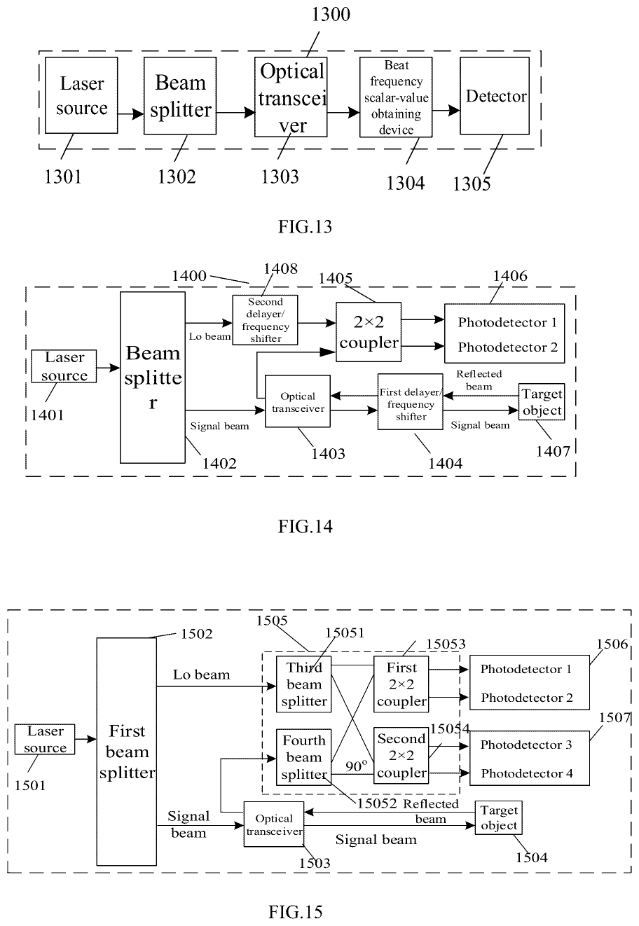

FIG. 13 shows a schematic diagram of the structure of the LiDAR system of the present application. In this embodiment, the LiDAR system includes: a laser light source 1301, configured to generate a frequency-sweeping light beam; a beam splitter 1302, configured to split the frequency-sweeping light beam into a signal light beam and a local-oscillation light beam; an optical transceiver 1303, configured to transmit the signal light beam and receive a reflected light beam generated by the signal light beam reflecting from an object; a beat frequency scalar-value obtaining device 1304, configured to perform time delay or frequency shift on at least one of the signal light beam, the reflected light beam and the local-oscillation light beam, and/or to perform in-phase quadrature (IQ) coherent demodulation on the local-oscillation light beam and the reflected light beam, so as to obtain the scalar values of the beat frequency in the frequency-increasing stage and the beat frequency in the frequency-decreasing stage between the local-oscillation light beam and the reflected light beam; and a detector 1305, configured to detect the beat frequency in the frequency-increasing stage and the beat frequency in the frequency-decreasing stage between the local-oscillation light beam and the reflected light beam, so as to determine the speed of the object and/or the distance between the object and the LiDAR system.

In some embodiments, the scalar value of the beat frequency in the frequency-increasing phase includes a positive value or a negative value or a zero value of the beat frequency of the frequency-increasing stage; the scalar value of the beat frequency in the frequency-decreasing phase includes a positive value or a zero value or a negative value of the beat frequency in the frequency-decreasing phase.

In some embodiments, the beat frequency scalar-value obtaining device 1304 specifically includes: a time delayer, configured to perform time delay on the signal light beam and the reflected light beam, or perform time delay on the local-oscillation light beam, so that the beat frequency of the frequency-increasing stage and the beat frequency of the frequency-decreasing stage between the local-oscillation light beam and the reflected light beam move toward the first direction or the second direction of the X axis of the ranging spectrum of the LiDAR system.

In some embodiments, the beat frequency scalar-value obtaining device 1304 specifically includes: a frequency shifter, configured to shift the frequency of the signal light beam or the local-oscillation light beam so that the beat frequency of the frequency-increasing stage and the beat frequency of the frequency-decreasing stage between the local-oscillation light beam and the reflected light beam are shifted toward the first direction or the second direction of the X axis of the ranging spectrum.

In some embodiments, the beat frequency scalar-value obtaining device 1304 specifically includes: a 90-degree frequency-mixer configured to receive the reflected light beam and the local-oscillation light beam to obtain the scalar values of the beat frequency in the frequency-increasing stage and the beat frequency in the frequency-decreasing stage between the local-oscillation light beam and the reflected light beam.

Optionally, the minimum value of the scalar values of the beat frequency in the frequency frequency-increasing stage and the beat frequency in the frequency frequency-decreasing stage is equal to the maximum negative frequency shift amount caused by the Doppler effect.

The system of the present application can implement the relevant steps of the above method embodiments. The same description can be found in the relevant description of the above method. In order to avoid repetition, details thereof will not be repeated here.

The detailed structure of the LiDAR system of the present application is described below. Referring to FIG. 14, FIG. 14 is a second schematic diagram of the detailed structure of the LiDAR system of the present application. The LiDAR system 1400 of the present application includes a laser light source 1401, a beam splitter 1402, an optical transceiver 1303, a first delay device 1304, a 2×2 optical coupler 1305, a balanced detector 1306, a target object 1307, and a second delay device or a first frequency shifter 1308.

The laser source 1401 is configured to generate a frequency-sweeping beam. The laser light source 1401 can be driven and modulated by a chirp signal of an optical signal. For example, a driving signal for controlling the laser source 1401 can be input to the laser source 1401 with an intensity that varies with time, so that the laser source 1401 generates and outputs the frequency-sweeping beam, i.e., a beam whose frequency varies within a predetermined range. The laser source 1401 may also include a modulator that receives a modulation signal. The modulator may be configured to modulate the light beam based on the modulation signal to generate and output the frequency-sweeping beam, the frequency of which varies within a predetermined range. The laser light source 1401 may be a laser source commonly used in FMCW LiDAR systems, and in order to avoid repetition, details thereof will not be described here.

The beam splitter 1402 is configured to split the frequency-sweeping light beam into a signal light beam and a local-oscillation light beam. The signal light beam and the local-oscillation light beam have the same frequency at any time instant, that is, the frequency modulation waveforms of the signal light beam and the local-oscillation light beam are exactly the same. In some examples, the beam splitter 1402 can be specifically a specific wavelength coupler (beam splitter) for wavelengths of 445 to 2100 nm, such as a beam splitter of a SMC series. In other examples, other beam splitters known to those skilled in the art that can split the frequency-sweeping light beam into a signal light beam and a local-oscillation light beam can also be used.

The signal light beam is incident onto a light incident port of the optical transceiver 1403. The optical transceiver 1403 is configured to transmit the signal light to a first delay device 1404. The first delay device 1404 can be specifically a time delay device or other device that can delay the light. The first delay device 1404 is configured to delay the signal light beam transmitted from the optical transceiver 1303.

The first delay device 1404 directs the delayed signal light beam toward the target object 1407. The reflected light of the delayed signal light beam after being reflected on the target object 1407 is delayed by the first delay device 1404, and the delayed reflected light beam reaches the optical transceiver 1403. The optical transceiver 1403 inputs the delayed reflected light beam to an input end of the 2×2 optical coupler 1405. The second delay device or the first frequency shifter 1408 is configured to delay or frequency-shift the local-oscillation light beam. The principle of delaying the signal light beam and the reflected light beam and the specific principle of delaying and frequency-shifting the local-oscillation light beam can be referred to the above related description of the method embodiments, and will not be described in detail here.

The 2×2 optical coupler 1405 is configured to mix the local-oscillation light beam and the reflected light beam. The mixed signal is, for example, a coherent signal generated by the interference between the local-oscillation light beam and the corresponding reflected light beam. The mixed signals are respectively sent to the photodetector 1406 for detection.

The system of the present application can implement the relevant steps of the above method embodiment. The same description can be found in the relevant description of the above method. In order to avoid repetition, details will not be repeated here.

The LiDAR system 1400 of this embodiment of the present application can delay both the signal light beam and the reflected light beam, and can also delay or frequency-shift the local-oscillation light beam, and can change the positions of the beat frequency in the frequency-increasing stage and the beat frequency in the frequency-decreasing stage between the local-oscillation light beam and the reflected light beam on the ranging spectrum, thereby expanding the ranging spectrum and avoiding the measurement blind area generated when calculating the distance and the speed of the target object.

FIG. 15 shows a detailed structural diagram of the LiDAR system of the present application. The LiDAR system 1500 of the present application includes a laser light source 1501, a first beam splitter 1502, an optical transceiver 1503, a target object 1504, a 90-degree mixer 1505, a first balanced detector 1506 and a second balanced detector 1507.

The laser source 1501 is configured to generate a frequency-sweeping beam. The laser light source 1501 can be directly driven and modulated by a chirp signal of an optical signal. The laser source 1501 can also include a modulator that receives a modulation signal. The modulator can be configured to modulate the light beam based on the modulation signal to generate and output a frequency-sweeping beam, the frequency of which varies within a predetermined range.

The first beam splitter 1502 is configured to split the frequency-sweeping beam into a signal light beam and a local-oscillation light beam. The signal light beam and the local-oscillation light beam have the same frequency at any time instant, that is, the frequency modulation waveforms of the signal light beam and the local-oscillation light beam are exactly the same. The first beam splitter 1502 can be specifically a specific wavelength coupler (beam splitter) for wavelengths of 445 to 2100 nm, such as a beam splitter of the SMC series.

The signal light beam is incident onto a light incident port of the optical transceiver 1503. The optical transceiver 1503 is configured to transmit the signal light beam to the target object 1504. The reflected light after the signal light beam is reflected on the target object 1504 is captured by the optical transceiver 1503. The optical transceiver 1503 transmits the reflected light beam to a first port of the 90-degree mixer 1505.

The 90-degree mixer 1505 is configured to perform 90-degree frequency-mixing on the local-oscillation light beam and the reflected light beam, and input the mixed signals to the first balanced detector 1506 and the second balanced detector 1507 for detection.

The 90-degree mixer includes a first input port, a second input port, a first output port, a second output port, a third output port, and a fourth output port. The 90-degree mixer is configured to coherently mix the local-oscillation light beam and the reflected light beam so that the relative phase differences of the four output ports are 0°, 90°, 180°, and 270°, respectively.

The 90-degree mixer may be any 90-degree mixer known to those skilled in the art. FIG. 15 shows an example of a 90-degree mixer. The 90-degree mixer 1505 includes a third beam splitter 15051, a fourth beam splitter 15052, a first 2×2 coupler 15053, and a second 2×2 coupler 15054. The third beam splitter 15051 is configured to receive a local-oscillation light beam from the first beam splitter 1502. The local-oscillation light beam is split into two beams, which are respectively input to the first 2×2 coupler 15053 and the second 2×2 coupler 15054. The fourth beam splitter 15052 is configured to receive a reflected light beam from the optical transceiver 1503. The reflected light beam is split into two beams, which are respectively input to the first 2×2 coupler 15053 and the second 2×2 coupler 15054.

The first 2×2 coupler 15053 is configured to couple the two light beams from the third beam splitter 15051 and the fourth beam splitter 15052 into two light beams with phases of 0° and 180°, respectively, and input the two light beams with phases of 0° and 180° to the first balanced detector 1506 through the first output port and the second output port. The first balanced detector 1506 includes a photodetector 1 and a photodetector 2, which are connected in series.

The second 2×2 coupler 15054 is configured to couple the two light beams from the third beam splitter 15051 and the fourth beam splitter 15052 into two light beams with phases of 90° and 270°, respectively, which are input to the second balanced detector 1507 through the third output port and the fourth output port. The second balanced detector 1507 includes a photodetector 3 and a photodetector 4. The photodetector 3 and the photodetector 4 are connected in series. The photodetector 3 is configured to receive the output light with the phase of 90°, and the photodetector 4 is configured to receive the output light with the phase of 270°.

The DC components of the photocurrents obtained by the balanced detectors for the light beams with the phases of 0° and 180° and the phases of 90° and 270° are equal.

The present application adopts the IQ coherent demodulation method to obtain the scalar values of the beat frequency in the frequency-increasing stage and the beat frequency in the frequency-decreasing stage, and can avoid the measurement blind area. The LiDAR system can implement the method steps described above. The relevant content of the LiDAR system 1500 can be obtained by referring to the relevant description of FIG. 7 above and will not repeated here.

By using a 90-degree mixer 1505, a first balanced detector 1506 and a second balanced detector 1507, the actual values of the beat frequencies in the frequency-increasing stage and the frequency-decreasing stage between the local-oscillation light beam and the reflected light beam can be obtained, and the beat frequencies in the frequency-increasing stage and the frequency-decreasing stage can be shifted, thereby expanding the ranging spectrum of the LiDAR system and avoiding the measurement blind area.

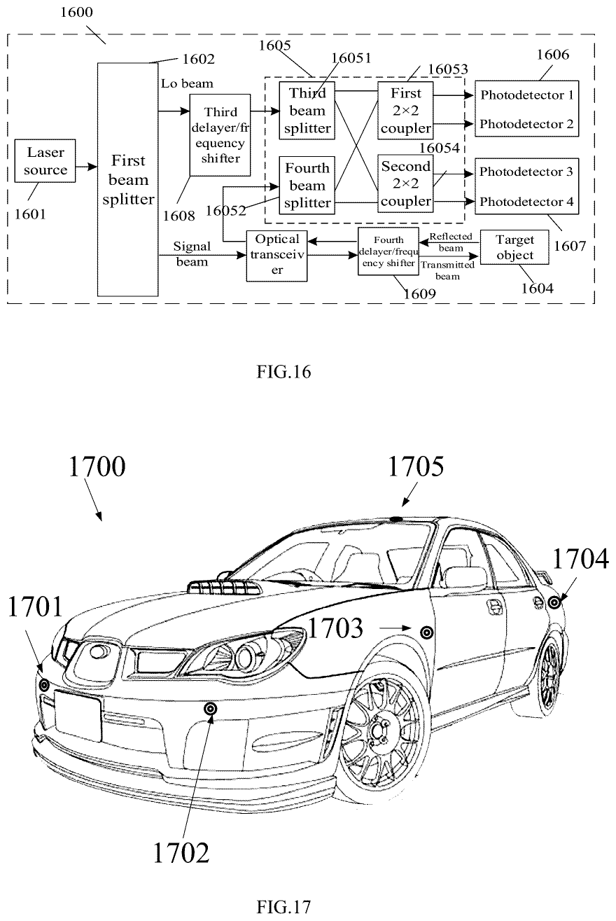

FIG. 16 shows a fourth detailed structural schematic diagram of the LiDAR system of the present application. The LiDAR system shown in FIG. 16 is similar to the LiDAR system shown in FIG. 15, except that the local-oscillation light beam output by the first beam splitter 1602 passes through the third delay device/third frequency shifter 1608 before reaching the 90-degree mixer 1605. The third delay device/third frequency shifter 1608 can delay or frequency-shift the local-oscillation light beam. The third delay device 1608 is configured to perform time delay on the local-oscillation light beam. The third frequency shifter 1608 is configured to perform frequency shift on the local-oscillation light beam. By delaying or frequency shifting the local-oscillation light beam, the beat frequency of the frequency-increasing phase and the beat frequency of the frequency-decreasing phase between the local-oscillation light beam and the reflected light beam obtained by the LiDAR system can be moved to the negative direction of the ranging spectrum, thereby expanding the range of the ranging spectrum, avoiding the measurement blind area caused by the beat frequency of the frequency-increasing phase and the beat frequency of the frequency-decreasing phase between the local-oscillation light beam and the reflected light beam being outside the ranging spectrum range of the LiDAR system, and improving the measurement accuracy.

Working principles of other elements and devices shown in FIG. 16 are similar to the working principles of the corresponding elements shown in FIG. 15. The specific contents thereof will not be described again to avoid repetition. The LiDAR system 1600 of the present application can make full use of the negative frequency range, expand the ranging spectrum of the LiDAR system, realize the full utilization of the spectrum, and improve the measurement accuracy.

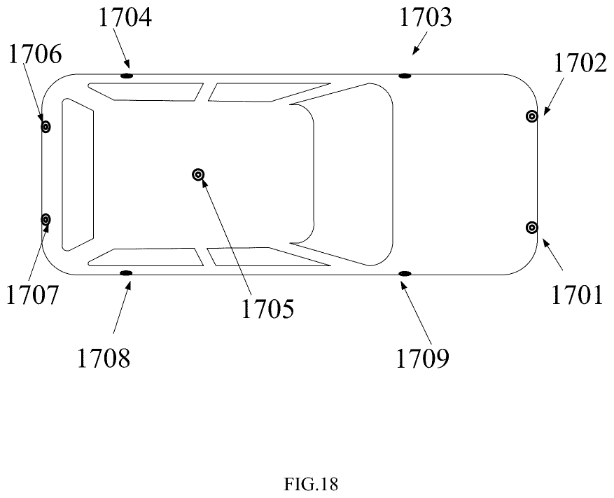

FIG. 17 and FIG. 18 illustrate an example autonomous vehicle 1700 according to an embodiment of the present application, which may include any of the components of the LIDAR system shown in FIG. 13-FIG. 15 of the present application. The autonomous vehicle 1700 shown includes a sensor array configured to capture one or more objects of the external environment of the autonomous vehicle and generate sensor data related to the captured one or more objects for controlling the operation of the autonomous vehicle 1700. FIG. 17 illustrates sensors 1701, 1702, 1703, 1704, and 1705. FIG. 18 illustrates sensors 1701, 1702, 1703, 1704, 1705, 1706, 1707, 1708, and 1709. FIG. 18 shows a top view of the autonomous vehicle 1700. Any one of the sensors 1701, 1702, 1703, 1704, 1705, 1706, 1707, 1708 and 1709 may include the LiDAR system shown in FIG. 13-FIG. 15 of the present application, which includes any LIDAR component of FIG. 1-FIG. 9. The autonomous vehicle may include a powertrain, which includes a prime mover powered by an energy source and capable of providing power to a transmission system. The autonomous vehicle may also include a control system, which includes direction control, powertrain control and braking control. The autonomous vehicle can be implemented as any number of different vehicles, including vehicles that can transport people and/or cargo and can travel in a variety of different environments. It should be understood that the above-mentioned components can vary widely based on the type of vehicle utilizing these components.

The details of this embodiment of the present disclosure can be obtained by referring to the description of the aforementioned method embodiment. To avoid repetition, details thereof will not be described again here.

Those skilled in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solutions. Those skilled in the art can use different methods to implement the described functions for each specific application, but such implementation should not be considered to be beyond the scope of the present disclosure.

Those skilled in the art can clearly understand that, for the convenience and brevity of description, the specific working processes of the systems, devices and units described above can be obtained by referring to the corresponding processes in the aforementioned method embodiments and will not be repeated here.

In the several embodiments provided by the present disclosure, it should be understood that the disclosed systems, devices and methods can be implemented in other ways. For example, the device embodiments described above are only schematic. For example, the division of the units is only a logical function division. There may be other division methods in actual implementation, such as multiple units or components can be combined or integrated into another system, or some features can be ignored or not executed. Mutual coupling or direct coupling or communication connection shown or discussed can be through some interfaces, indirect coupling or communication connection of devices or units, which can be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the embodiments of the present disclosure.

In addition, each functional unit in each embodiment of the present disclosure may be integrated into one processing unit, or each unit may exist physically separately, or two or more units may be integrated into one unit.

If the functions are implemented in the form of software functional units and sold or used as independent products, they can be stored in a computer-readable storage medium. Based on this understanding, an essential part, or the part that contributes to the related art or the part of the technical solution, can be embodied in the form of a software product. The computer software product is stored in a storage medium, including several instructions to enable a computer device (which can be a personal computer, server, or network device, etc.) to perform all or part of the steps of the method described in each embodiment of the present disclosure. The aforementioned storage medium includes: a U disk, a mobile hard disk, a read-only memory (ROM), a random access memory (RAM), a disk or an optical disk, etc., various media that can store program codes.

The computer-readable storage medium mentioned in the present disclosure may be volatile or non-volatile.

The above describes only specific embodiments of the present disclosure, but the protection scope of the present disclosure is not limited thereto. Any person skilled in the art can easily think of changes or substitutions within the technical scope disclosed by the present disclosure, which should be included in the protection scope of the present disclosure. Therefore, the protection scope of the present disclosure should be consistent with the protection scope of the claims.

What is claimed is:

1. A Light Detection And Ranging (LiDAR) method applied to a LiDAR system, comprising:
generating a frequency-sweeping beam;
splitting the frequency-sweeping beam into a signal light beam and a local-oscillation light beam;
transmitting the signal light beam;
receiving a reflected light beam generated when the signal light beam is reflected by an object;
performing time delay or frequency-shift on at least one of the signal light beam, the reflected light beam or the local-oscillation light beam, and/or performing in-phase quadrature coherent demodulation on the local-oscillation light beam and the reflected light beam, so as to obtain scalar values of a beat frequency between the local-oscillation light beam and the reflected light beam in a frequency-increasing phase and a beat frequency between the local-oscillation light beam and the reflected light beam in a frequency-decreasing phase; and
detecting the beat frequency between the local-oscillation light beam and the reflected light beam in the frequency-increasing phase and the beat frequency between the local-oscillation light beam and the reflected light beam in the frequency-decreasing phase, to determine a speed of the object and/or a distance between the object and the LiDAR system.

2. The LiDAR method according to claim 1, wherein the scalar value of the beat frequency in the frequency-increasing stage comprises a positive value, a zero value, or a negative value of the beat frequency of the frequency-increasing stage;
the scalar value of the beat frequency in the frequency-decreasing stage comprises a positive value, a zero value, or a negative value of the beat frequency of the frequency-decreasing stage.

3. The LiDAR method according to claim 1, wherein performing the time delay or the frequency-shift on at least one of the signal light beam, the reflected light beam or the local-oscillation light beam comprises:
delaying the signal light beam and the reflected light beam, or delaying the local-oscillation light beam, so that the beat frequency between the local-oscillation light beam and the reflected light beam of the frequency-increasing phase and the beat frequency between the local-oscillation light beam and the reflected light beam of the frequency-decreasing phase move toward a first direction or a second direction of a ranging spectrum of the LiDAR system.

4. The LiDAR method according to claim 1, wherein performing the time delay or the frequency-shift on at least one of the signal light beam, the reflected light beam or the local-oscillation light beam comprises:
performing frequency-shift of a frequency of the signal light beam or the local-oscillation light beam, so that the beat frequency of the frequency-increasing phase and the beat frequency of the frequency-decreasing phase between the local-oscillation light beam and the reflected light beam are shifted toward a first direction or a second direction of the ranging spectrum.

5. The LiDAR method according to claim 1, wherein performing the in-phase quadrature coherent demodulation on the local-oscillation light beam and the reflected light beam so as to obtain the scalar values of the beat frequency between the local-oscillation light beam and the reflected light beam in the frequency-increasing phase and the beat frequency between the local-oscillation light beam and the reflected light beam in the frequency-decreasing phase comprises:
inputting the reflected light beam and the local-oscillation light beam into a 90-degree frequency-mixer to obtain the scalar values of the beat frequency between the local-oscillation light beam and the reflected light beam in the frequency-increasing phase and the beat frequency between the local-oscillation light beam and the reflected light beam in the frequency-decreasing phase.

6. The LiDAR method according to claim 5, wherein a minimum value of the scalar values of the beat frequency in the frequency-increasing stage and the beat frequency in the frequency-decreasing stage is equal to a maximum negative frequency shift amount caused by the Doppler effect.

7. The LiDAR method according to claim 2, wherein performing the time delay or the frequency-shift on at least one of the signal light beam, the reflected light beam or the local-oscillation light beam comprises:
delaying the signal light beam and the reflected light beam, or delaying the local-oscillation light beam, so that the beat frequency between the local-oscillation light beam and the reflected light beam of the frequency-increasing phase and the beat frequency between the local-oscillation light beam and the reflected light beam of the frequency-decreasing phase move toward a first direction or a second direction of a ranging spectrum of the LiDAR system.

8. The LiDAR method according to claim 2, wherein performing the time delay or the frequency-shift on at least one of the signal light beam, the reflected light beam or the local-oscillation light beam comprises:
performing frequency-shift of a frequency of the signal light beam or the local-oscillation light beam, so that the beat frequency of the frequency-increasing phase and the beat frequency of the frequency-decreasing phase between the local-oscillation light beam and the reflected light beam are shifted toward a first direction or a second direction of the ranging spectrum.

9. The LiDAR method according to claim 2, wherein performing the in-phase quadrature coherent demodulation on the local-oscillation light beam and the reflected light beam so as to obtain the scalar values of the beat frequency between the local-oscillation light beam and the reflected light beam in the frequency-increasing phase and the beat frequency between the local-oscillation light beam and the reflected light beam in the frequency-decreasing phase comprises:
inputting the reflected light beam and the local-oscillation light beam into a 90-degree frequency-mixer to obtain the scalar values of the beat frequency between the local-oscillation light beam and the reflected light beam in the frequency-increasing phase and the beat frequency between the local-oscillation light beam and the reflected light beam in the frequency-decreasing phase.

10. A Light Detection And Ranging (LiDAR) system, comprising:
a laser light source configured to generate a frequency-sweeping beam;
a beam splitter configured to split the frequency-sweeping beam into a signal light beam and a local-oscillation light beam;
an optical transceiver configured to transmit the signal light beam and receive a reflected light beam generated when the signal light beam is reflected by an object;
a beat frequency scalar-value obtaining device, configured to perform time delay or frequency-shift on at least one of the signal light beam, the reflected light beam or the local-oscillation light beam, and/or perform in-phase quadrature coherent demodulation on the local-oscillation light beam and the reflected light beam, so as to obtain scalar values of a beat frequency between the local-oscillation light beam and the reflected light beam in a frequency-increasing phase and a beat frequency between the local-oscillation light beam and the reflected light beam in a frequency-decreasing phase; and
a detector configured to detect the beat frequency between the local-oscillation light beam and the reflected light beam in the frequency-increasing phase and the beat frequency between the local-oscillation light beam and the reflected light beam in the frequency-decreasing phase, to determine a speed of the object and/or a distance between the object and the LiDAR system.

11. The LiDAR system according to claim 10, wherein the scalar value of the beat frequency in the frequency-increasing stage comprises a positive value, a zero value, or a negative value of the beat frequency of the frequency-increasing stage;
the scalar value of the beat frequency in the frequency-decreasing stage comprises a positive value, a zero value, or a negative value of the beat frequency of the frequency-decreasing stage.

12. The LiDAR system according to claim 10, wherein the beat frequency scalar-value obtaining device specifically comprises:
a time delayer configured to delay the signal light beam and the reflected light beam, or delay the local-oscillation light beam, so that the beat frequency between the local-oscillation light beam and the reflected light beam of the frequency-increasing phase and the beat frequency between the local-oscillation light beam and the reflected light beam of the frequency-decreasing phase move toward a first direction or a second direction of a ranging spectrum of the LiDAR system.

13. The LiDAR system according to claim 10, wherein the beat frequency scalar-value obtaining device specifically comprises:
a frequency shifter configured to perform frequency-shift of a frequency of the signal light beam or the local-oscillation light beam, so that the beat frequency of the frequency-increasing phase and the beat frequency of the frequency-decreasing phase between the local-oscillation light beam and the reflected light beam are shifted toward a first direction or a second direction of the ranging spectrum.

14. The LiDAR system according to claim 10, wherein the beat frequency scalar-value obtaining device comprises:
a 90-degree frequency-mixer configured to receive the reflected light beam and the local-oscillation light beam to obtain the scalar values of the beat frequency between the local-oscillation light beam and the reflected light beam in the frequency-increasing phase and the beat frequency between the local-oscillation light beam and the reflected light beam in the frequency-decreasing phase.

15. The LiDAR system according to claim 14, wherein a minimum value of the scalar values of the beat frequency in the frequency-increasing stage and the beat frequency in the frequency-decreasing stage is equal to a maximum negative frequency shift amount caused by the Doppler effect.

16. The LiDAR system according to claim 11, wherein the beat frequency scalar-value obtaining device specifically comprises:
a time delayer configured to delay the signal light beam and the reflected light beam, or delay the local-oscillation light beam, so that the beat frequency between the local-oscillation light beam and the reflected light beam of the frequency-increasing phase and the beat frequency between the local-oscillation light beam and the reflected light beam of the frequency-decreasing phase move toward a first direction or a second direction of a ranging spectrum of the LiDAR system.

17. The LiDAR system according to claim 11, wherein the beat frequency scalar-value obtaining device specifically comprises:
a frequency shifter configured to perform frequency-shift of a frequency of the signal light beam or the local-oscillation light beam, so that the beat frequency of the frequency-increasing phase and the beat frequency of the frequency-decreasing phase between the local-oscillation light beam and the reflected light beam are shifted toward a first direction or a second direction of the ranging spectrum.

18. The LiDAR system according to claim 11, wherein the beat frequency scalar-value obtaining device comprises:
a 90-degree frequency-mixer configured to receive the reflected light beam and the local-oscillation light beam to obtain the scalar values of the beat frequency between the local-oscillation light beam and the reflected light beam in the frequency-increasing phase and the beat frequency between the local-oscillation light beam and the reflected light beam in the frequency-decreasing phase.

19. An autonomous vehicle, comprising:
a Light Detection And Ranging (LiDAR) system, wherein the LiDAR system comprises:
a laser light source configured to generate a frequency-sweeping beam;
a beam splitter configured to split the frequency-sweeping beam into a signal light beam and a local-oscillation light beam;
an optical transceiver configured to transmit the signal light beam and receive a reflected light beam generated when the signal light beam is reflected by an object;
a beat frequency scalar-value obtaining device, configured to perform time delay or frequency-shift on at least one of the signal light beam, the reflected light beam or the local-oscillation light beam, and/or perform in-phase quadrature coherent demodulation on the local-oscillation light beam and the reflected light beam, so as to obtain scalar values of a beat frequency between the local-oscillation light beam and the reflected light beam in a frequency-increasing phase and a beat frequency between the local-oscillation light beam and the reflected light beam in a frequency-decreasing phase; and
a detector configured to detect the beat frequency between the local-oscillation light beam and the reflected light beam in the frequency-increasing phase and the beat frequency between the local-oscillation light beam and the reflected light beam in the frequency-decreasing phase, to determine a speed of the object and/or a distance between the object and the LiDAR system.

20. The autonomous vehicle according to claim 19, wherein the scalar value of the beat frequency in the frequency-increasing stage comprises a positive value, a zero value, or a negative value of the beat frequency of the frequency-increasing stage;
the scalar value of the beat frequency in the frequency-decreasing stage comprises a positive value, a zero value, or a negative value of the beat frequency of the frequency-decreasing stage.
